(19) United States
(12) Patent Application Publication
(10) Pub. No.: US 2016/0110325 A1
(43) Pub. Date: Apr. 21, 2016

(54) Method of Sharing Radiation Therapy Information to Non-Radiation Therapy Practitioners

(71) Applicant: Materials Engineering and Packaging, LLC, St. Louis, MO (US)

(72) Inventors: Parag Parikh, St. Louis, MO (US); Hanlin Wan, St. Louis, MO (US)

(21) Appl. No.: 14/887,879

(22) Filed: Oct. 20, 2015

Related U.S. Application Data
(60) Provisional application No. 62/065,906, filed on Oct. 20, 2014.

(51) Int. Cl. G06F 17/22; G06F 19/00; G06F 17/21

(52) U.S. Cl. CPC G06F 17/2264; G06F 17/211; G06F 19/321

(57) ABSTRACT

A system and method for converting radiation therapy information into another form, the converted radiation therapy information being placed in a format such that it can be stored in any storage system, including PACS storages systems, irrespective of the implementation of DICOM; the converted radiation therapy information being expressed in a manner that is proportional/equivalent to a standard imaging parameter for CT or PET.

### FIELD OF THE INVENTION

This invention is in the field of medical image processing. Specifically, it may be used in the transformation of radiation therapy information to a format usable to non-radiation therapy practitioners.

### BACKGROUND OF THE INVENTION

Almost ⅓^{rd} of cancer patients are treated with radiation therapy. Radiation therapy may use specialized devices to focus therapeutic doses of radiation towards specific anatomic areas of the body. In the past 20 years, the ability of these devices to focus the radiation very precisely has greatly increased. Nowadays, almost all radiation therapy is planned using volumetric imaging of the body (CT/MRI/PET) and the delivery is precisely aimed at the specific areas of disease noted on this imaging.

Currently, information regarding the radiation therapy delivery is not easily accessible outside of radiation oncology. For example, radiation dose information is traditionally kept in proprietary data structures in radiation treatment planning systems. These systems keep not only the planned radiation therapy dose, but also all of the accoutrements of the delivery, such as the angle of the beams, the shape of each field, the energy of the beam used etc.

To offer some interoperability between radiation therapy planning systems, an extension to the DICOM (Digital Imaging and Communications in Medicine) format, traditionally referred to as ‘DICOM-RT’, was developed in 1996. This standard was optimized for transfer of radiation therapy information in different parts of the radiation therapy department; such as from the area where the radiation is planned to the software used to control the radiation delivery devices. Also, this standard was created prior to the routine use of volumetric imaging taken prior to planning radiation therapy dose information. For this reason, development of tools to display radiation therapy dose have been limited to specific products used only in the radiation therapy department. Commercial examples include Varian Eclipse, Philips Pinnacle, Elekta Mosaiq, Elekta Monaco, and Varian Aria.

Other physicians involved in the patients' care, such as surgeons, medical oncologists, and primary care providers, often need to evaluate these changes in tissue and assess whether these were a result of delivered radiation therapy, or another disease process. They often order diagnostic imaging to measure these changes.

The most common physician asked to evaluate the imaging is the diagnostic radiologist. Patients may receive diagnostic imaging, such as x-ray, ultrasound, CT, PET, MRI; and the diagnostic radiologist is asked to interpret the images to render a diagnosis for the patient. Without knowing about the delivered radiation therapy information, the patient is at risk for a misdiagnosis. Patients have been misdiagnosed with radiation damage to the lungs when they actually have a pneumonia; or have been diagnosed with recurrent brain tumors when they actually have damage from radiation therapy [Alexiou G A et al. Neurooncol. 2009 October;95(1):1-11.]

Radiologists most often rely on a written description of the general area of the body that has received radiation. The radiologist must rely on the changes from prior imaging to the current imaging to make an accurate diagnosis. This is commonly done by using a PACS, or Picture Archiving Computer System, to store previous imaging and display it at the time of analysis of the newest imaging. Examples of these PACS systems include Siemens Syngo, Merge RadSuite, Philips Intellispace, etc. These PACS support DICOM, and can read images stored in this format since 1985. However, even close to 20 years since the introduction of ‘DICOM-RT,’ they do not support this format due to the complexity and cost to implement the standard.

Some software has been developed to display radiation therapy dose outside of radiation therapy departments. Unfortunately, use of this software relies on the diagnostic radiologist, or other involved physician, to either purchase a new PACS (such as MlMvista by MIM) or open a separate application (such as Fulaccess by Radiologica) that is separate from the PACS that stores the current diagnostic study. This is associated with either a high cost, a workflow problem, or both.

There exists a need to show radiation therapy information in the context of evaluating a new diagnostic image. More specifically, there exists a need to convert radiation therapy information into a format such that it can be stored in any storage system (such as PACS), irrespective of the implementation of for example, DICOM. The invention described below describes a novel method to perform this task.

### SUMMARY OF THE INVENTION

The present invention is directed to a system and method for the transformation of radiation therapy information from a first format to a second format that is usable to non-radiation therapy practitioners.

The system may receive radiation therapy information in a first format, and convert the same to radiation therapy information in a second format. The converted radiation therapy information is placed in a format such that it can be stored in any storage system, including PACS storage systems, irrespective of the implementation of DICOM. The converted radiation therapy information is expressed in a manner that is proportional/equivalent to a standard imaging parameter for CT or PET. In particular, the converted radiation therapy information is expressed in a manner where 1 cGY is proportional/equivalent to 1 HU, or where 1 GY is proportional/equivalent to 1 SUV.

Both the foregoing general description and the following detailed description are exemplary and explanatory only and are intended to provide further explanation of the invention as claimed. The accompanying drawings are included to provide a further understanding of the invention; are incorporated in and constitute part of this specification; illustrate embodiments of the invention; and, together with the description, serve to explain the principles of the invention.

### BRIEF DESCRIPTION OF THE DRAWINGS

Further features and advantages of the invention can be ascertained from the following detailed description that is provided in connection with the drawings described below:

FIG. 1 illustrates a computer architecture on which the present invention may operate, in one embodiment.

FIG. 2 is a flowchart showing exemplary step by the step processes of converting RTDOSE DICOM files into new files that are compatible with any DICOM viewer (such files will be referred to herein as RTforDR files).

### DETAILED DESCRIPTION OF THE INVENTION

The following disclosure discusses the present invention with reference to the examples shown in the accompanying drawings, though does not limit the invention to those examples.

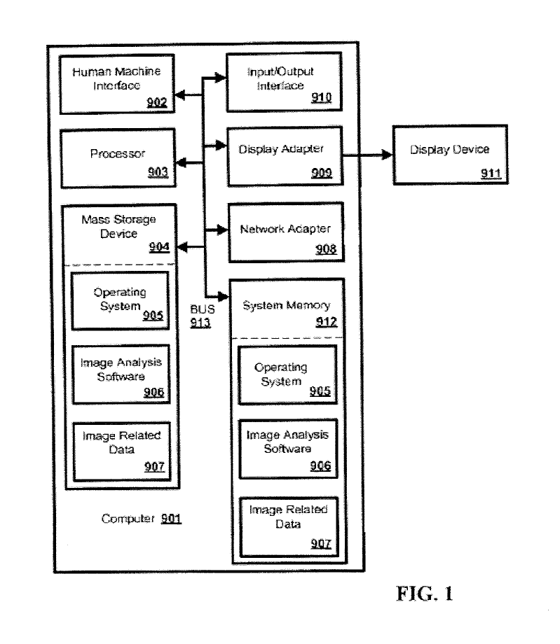

With respect to FIG. 1, in one embodiment the present invention may comprise a computer 901 that includes a processor 903 that takes in radiation dose information, a reference 3D image set (stored in, for example, a portion 907 of a storage device 904), and outputs the radiation dose information (such as via input-output interface 910) in a format accessible to another storage system, such as a PACS system.

In one embodiment, the system of FIG. 1 also may include one or more human/machine interfaces 902 (keyboard, mouse, etc.), a display adapter 909 for displaying output on a display device 911, a network adapter 908 for connecting to a network, and a system memory 912 for use by the processor 903. The system memory 912 may, in one embodiment, be used for the operating system 905, image analysis software 906 and image related data 907. The storage device 904 may be used to store an operating system 905 (for use by the processor 903), image analysis software 906 and image related data 907 (as previously discussed).

The radiation dose information stored in storage device 904 may be in, for example, the DICOM-RT format, or in a vendor specific proprietary format from the radiation treatment system.

The reference 3D image set may be a DICOM-CT image set, but can be any volumetric imaging such as DICOM-MR, DICOM-PET, DICOM-US, etc.

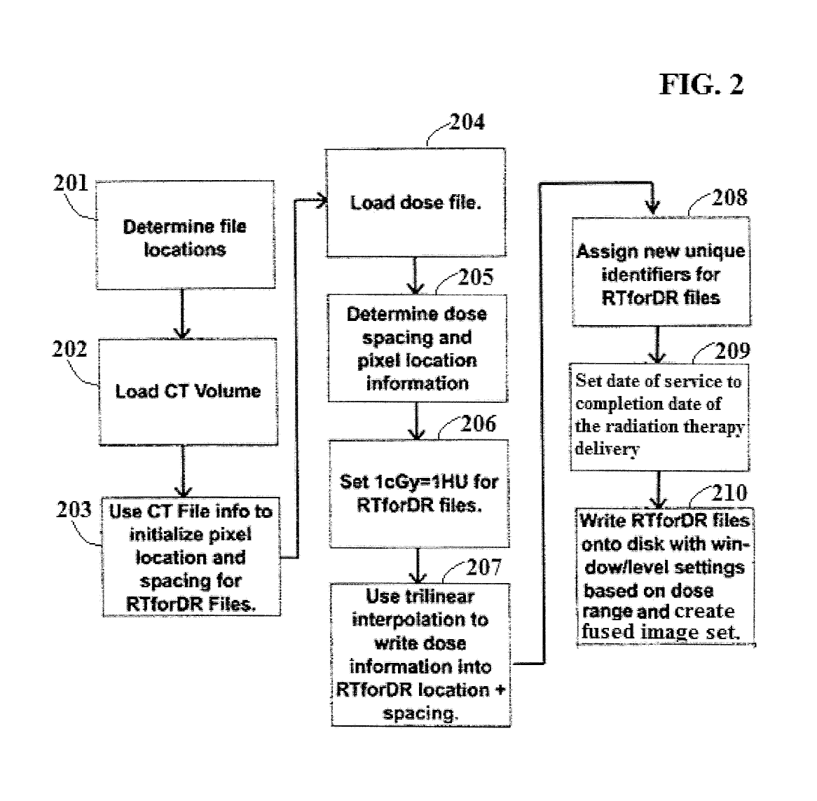

With reference to FIG. 2, the present invention may operate as follows, in one embodiment. Referring to FIG. 2, processor 903 first determines the location of all of the relevant files in step 201 (such as within storage 904). This includes the CT slice files as well as the dose file. In one embodiment, they may all be stored in the same folder.

In step 202, each CT slice is loaded by processor 903. In an exemplary system, the format may be DICOM-CT.

In step 203, DICOM tags including Columns, Rows, ImagePostionPatient, and PixelSpacing may be used to determine the exact 3D location that each CT pixel value represents in space. The ability to perform this is known to those skilled in the art.

In step 204, the dose file may be loaded. In an exemplary system, the format is DICOM-RTDOSE.

In step 205, DICOM tags including Width, Height, NumberOfFrames, ImagePositionPatient, PixelSpacing, and GridFrameOffsetVector may be used to determine the exact 3D location that each dose pixel value represents in space, similar to step 203 with the CT images. An additional DICOM tag, DoseGridScaling, is needed to convert the raw numbers stored into the appropriate dose values, with units of cGy. In one embodiment, an equality of 1 HU from the CT files equaling 1 cGy from the RTDOSE file may be used (step 206).

In step 207, the main calculation part of the present invention is performed. For each pixel location in each CT file, the dose value is calculated by interpolation, using the known locations for each dose voxel and the dose values in those locations. This can be performed using trilinear, spline, or any other interpolation methods (we used trilinear). In the exemplary system, the CT pixel value is then overwritten with the interpolated dose value.

In step 208, new unique IDs are written to the new RTforDR DICOM files to prevent conflicts with viewers. This includes DICOM header tags SeriesinstanceUID, ImplementationClassUID, MediaStorageSOPInstanceUID, and SOPInstanceUID.

In step 209, the date of service may be set to correspond with the date of completion of the radiation therapy delivery.

In step 210, other settings may also be written into the RTforDR header files including information on window levels used by the DICOM viewers. These are used by DICOM viewers for the default settings used to view the images. These tags include SmallestImagePixelValue, LargestImagePixelValue, WindowCenter, WindowWidth, RescaleIntercept, and RescaleSlope. In the exemplary system, the WindowCenter and WindowWidth are automatically set based on the range and distribution of the radiation dose; or can be entered in separately by the user.

Finally, in step 210, the processor 903 then creates a fused image of the 3D reference image displayed in greyscale, and the RTforDR images in a colorwash, along with a legend showing the scale of the color with respect to absolute radiation dose. The new RTforDR files are written to storage (such as in 904).

Some of the novel aspects of the present invention include converting radiation therapy dose information such that:
1) It can be viewed in any PACS system that conforms to the first DICOM standards established in 1985.
2) In one implementation, the radiation dose is proportional to the Hounsfield units (HU) of a CT scan.
3) In another implementation, the radiation dose is proportional to the SUV of a PET scan
4) In a third implementation, the radiation dose is proportional to the intensity value of an MRI.

Though the present invention is described with reference to particular embodiments, the foregoing disclosure addresses exemplary embodiments only, and other variations of the present invention will be apparent to one of ordinary skill in the art. The above examples and embodiments are merely intended to illustrate an exemplary implementation of the structure and operation of the present invention. The scope of the invention is not limited by the foregoing embodiments, and may encompass additional embodiments embracing various changes and modifications relative to the examples disclosed herein without departing from the scope of the invention as defined in the appended claims and equivalents thereto.

To the extent necessary to understand or complete the disclosure of the present invention, all publications, patents, and patent applications mentioned herein are expressly incorporated by reference herein to the same extent as though each were individually so incorporated.

The present invention is not limited to the exemplary embodiments illustrated herein, but is instead characterized by the appended claims.

What is claimed is:

1. A system for converting radiation therapy information into another form.

2. A system for converting radiation therapy information into a format such that it can be stored in any storage system.

3. The system of claim 2, wherein the storage system comprises PACS.

4. A system for converting radiation therapy information into a format such that it can be stored in any storage system, irrespective of the implementation of, for example, DICOM.

5. A method for converting radiation therapy information into another form.

6. A method for converting radiation therapy information into a format such that it can be stored in any storage system.

7. The method of claim 6, wherein the storage system comprises PACS.

8. A method for converting radiation therapy information into a format such that it can be stored in any storage system, irrespective of the implementation of, for example, DICOM.

9. The system of claim 1, wherein the system is configured to express the converted radiation therapy information in a manner that is proportional/equivalent to a standard imaging parameter for CT or PET.

10. The system of claim 9, wherein the system is configured to express the converted radiation therapy information in a manner where 1 cGY is proportional/equivalent to 1 HU.

11. The system of claim 9, wherein the system is configured to express the converted radiation therapy information in a manner where 1 GY is proportional/equivalent to 1 SUV.

12. The method of claim 5, wherein conversion of the radiation therapy information comprises expressing the radiation therapy information in a manner that is proportional/equivalent to a standard imaging parameter for CT or PET.

13. The system of claim 12, wherein the converted radiation therapy information is expressed in a manner where 1 cGY is proportional/equivalent to 1 HU.

14. The system of claim 12, wherein the converted radiation therapy information is expressed in a manner where 1 GY is proportional/equivalent to 1 SUV.
